(19) United States
(12) Patent Application Publication
(10) Pub. No.: US 2007/0113095 A1
(43) Pub. Date: May 17, 2007

(54) ENCRYPTION SCHEME MANAGEMENT METHOD

(75) Inventors: Shin'ichi MARUI, Osaka (JP); Natsume MATSUZAKI, Osaka (JP); Toshihisa NAKANO, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/559,459

(22) Filed: Nov. 14, 2006

(30) Foreign Application Priority Data
Nov. 15, 2005 (JP) 2005/330687

(51) Int. Cl. H04L 9/00

(52) U.S. Cl. 713/178

(57) ABSTRACT

An encryption scheme management method according to the present invention is an encryption scheme management method which manages encryption schemes utilized for distributing encrypted data, and includes request receiving which receives encryption scheme switching request from a client device, selecting an encryption scheme from the encryption schemes, generating circuit forming information for forming a decrypting circuit which decrypts the data encrypted by the selected encryption scheme, and sending the circuit forming information to the client device.

### BACKGROUND OF THE INVENTION

(1) Field of the Invention

The present invention relates to an encryption scheme management method for managing encryption schemes used for distributing encrypted data.

(2) Description of the Related Art

Along with the spread of broadband networks, there are services in which a content vendor distributes content data according to a client's (user's) request. In this service, in general, when requesting the content, a user who has already signed up with a content vendor is authenticated and the user receives the distributed content afterward. Here, the user authentication utilizes password entry and the like. With this technology, a content server ensures security of the content data, and subsequently, non-encrypted content data is distributed via a network. The receiving side (user) views the received content data after decoding the data using software (for example, see Non-Patent Reference 1)

In addition, there is an encryption method for encrypting content data so that higher safety is ensured and the content vendor can safely distribute the content data (for example, see Patent Reference 1).

In Patent Reference 1, a method for encrypting content data using a reconfigurable device is introduced. The encryption managing method according to Patent Reference 1 distributes encrypted data which includes individual parameters for each client. Since other clients cannot decode the content data distributed to each client, high security is ensured.
[Non-Patent Reference 1] Technology Reserch Section, Japan Patent Office General Administration Department “Patent Application Technology Trend Survey on Digital Contents Delivery and Distribution”
http://www.jpo.go.jp/shiryou/pdf/gidou-houkoku/dc.pdf
[Patent Reference 1] Japanese Laid-Open Patent Application 2005-6302

### SUMMARY OF THE INVENTION

However, in conventional encryption schemes management methods, a fixed encryption scheme is utilized for encrypting content data, and thus content data can be analyzed relatively easy once the encryption scheme is analyzed.

An object of the present invention is to provide an encryption updating method that can ensure high security.

In order to achieve the abovementioned objective, an encryption scheme management method according to the present invention is an encryption scheme management method for managing encryption schemes utilized for a distribution of encrypted data, the method includes: sending an encryption scheme switching request from a client device to a server device; receiving the encryption scheme switching request in the server device; selecting, in the server device, an encryption scheme from among the encryption schemes after the encryption scheme switching request is received; generating configuration data for forming a circuit in the reconfigurable device equipped in the client device, the circuit being for decrypting the encrypted data encrypted in the selected encryption scheme in either the server device or the client device; and forming a circuit in the reconfigurable device, using the configuration data in the client device, the circuit being for decrypting the encrypted data encrypted with the selected encryption scheme.

Thus, the encryption managing method according to the present invention is constructed as a circuit which decrypts the encrypted data encrypted with an encryption scheme selected from the encryption schemes in a reconfigurable device equipped in the client device. The client device decrypts the encrypted data decrypted by the selected encryption scheme in a circuit formed in the reconfigurable device. Thus, the client device can form a decrypting circuit for a predetermined encryption scheme. Since the server device sends encrypted data encrypted not with a fixed encryption scheme but with various encryption schemes, even if one of the encryption schemes is decoded by third party, content data is not easily decrypted. Thus, the encryption managing method according to the present invention can ensure high security when distributing data. In addition, the circuit for decoding the encrypted data is formed in the reconfigurable device equipped in the client device, and therefore it is unnecessary for the client device to modify the hardware of the decrypting device. Thus, the encryption managing device according to the present invention does not need a great amount of time on the client device when the data encryption scheme is switched.

In addition, the encryption scheme management method further includes: sending device information of the reconfigurable device from the client device to the server device; and obtaining, in the server device, the device information of the reconfigurable device, wherein, in the generating of configuration data, the server device generates configuration data adapted to the reconfigurable device, using the obtained device information, and the encryption scheme management method may include sending the configuration data from the server device to the client device.

Thus, the server device can generate configuration data adapted to the reconfigurable device in the server device using the obtained device information. The server device can thus generate configuration data compliant with the reconfigurable device when the model of the reconfigurable device in the client device varies.

In addition, the encryption scheme management method may further include: sending a unique user ID held by the client device from the client device to the server device; and obtaining the user ID in the server device, wherein, in the generating of configuration data, configuration data for forming a circuit dependent on the user ID in the reconfigurable device may be generated, and in the forming the circuit, the circuit dependent on the user ID may be formed in the reconfigurable device.

Thus, the encrypted data cannot be decrypted except for the client who sent the data distribution request. Therefore, high security is ensured for data distribution.

In addition, the generating of configuration data may further include: obtaining a program of the selected encryption scheme algorithm written in either a high-level programming language or a hardware description language; and converting the program into configuration data.

Thus, configuration data compliant with the reconfigurable devices in each client device can be generated with a program written in either a high-level programming language or a hardware description language independent of the model of each reconfigurable device. As a result, the server device may only store algorithms of encryption schemes, and the amount of data stored can be reduced when algorithms of encryption scheme is already known. In addition, this configuration can also be used for encryption schemes whose algorithms are known, and thus workload can be reduced.

In addition, the encryption scheme management method may further include: generating a program, in the server device, written in either a high-level programming language or a hardware description language, the program being for forming, in the reconfigurable device, a circuit for decrypting the encrypted data encrypted with the selected encryption scheme; sending the program from the server device to the client device; and receiving the program in the client device, wherein, in the generating of configuration data, the client device may convert the program into configuration data.

Thus, the server device sends a program written in a high-level programming language or a hardware description language to the client device. Since information on circuit configuration to be formed in the reconfigurable device is not included in this program, the information of a decrypting circuit to be formed in the reconfigurable device equipped in the client device is not revealed to outside of the device. Therefore, high security is ensured for data distribution. In addition, the server device can generate a program and send the program to the client device regardless of the model of the reconfigurable device in the client device. In other words, the server device is not required to obtain device information of the reconfigurable device in the client device. Thus, the amount of data transmitted between the server device and the client device can be reduced. It is also noted that the processing in the server device can be reduced as well.

In addition, the encryption scheme management method may further include: sending a unique user ID held by the client device has from the client device to the server device; and obtaining the user ID in the server device, wherein, in the generating of the program, the program for forming a circuit dependent on the user ID may be generated, in the generating of the configuration data, the configuration data may be generated for forming a circuit in the reconfigurable device, the circuit being dependent on the user ID, in the forming of the circuit, the circuit dependent on the user ID may be formed in the reconfigurable device.

Thus, the encrypted data cannot be decrypted except for the client who sent the data distribution request even if a device utilized for decrypting the data encrypted by the same encryption scheme is utilized. Therefore, high security is ensured when distributing data.

In addition, the encryption scheme switching request may include an encryption scheme request utilized for encryption, and in the selecting of an encryption scheme, an encryption scheme specified in the encryption scheme request may be selected.

Thus, the circuit for encrypting the encryption scheme requested by the client device can be formed in the reconfigurable device equipped in the client device. The client device can thus decrypt the data encrypted by the encryption scheme requested by the client device.

In addition, in the selecting of an encryption scheme, an encryption scheme may be selected independently of the request from the client device.

Thus, the client does not know the encryption scheme to be decoded by the circuit formed in the reconfigurable device. In other words, the selected encryption schemes cannot be seen from outside. Therefore, even if the encrypted data is obtained in an unauthorized manner, it is difficult to decrypt the encrypted data. Therefore, high security is ensured when distributing data.

In addition, the encryption scheme management method may further include obtaining a condition of a circuit to be formed in the reconfigurable device by either the server device or the client device, wherein, in the generating of configuration data, configuration data reflecting the obtained condition may be generated, in the forming, a circuit reflecting the obtained condition may be formed in the reconfigurable device.

Thus, the circuit to be formed in the reconfigurable device reflects the received circuit condition. Thus, a circuit for decrypting the encryption scheme can be formed adapting the usage environment of the client device.

In addition, the condition of the circuit may include a condition whether or not the circuit to be formed in the reconfigurable device is a low-electric consumption circuit.

Thus, a circuit, with a priority in low-electric consumption, for decrypting the encrypted data encrypted by the selected encryption scheme can be formed in the reconfigurable device equipped in the client device.

Note that the present invention can be realized not only as an encryption managing method, but also as an encryption managing device using the steps included in the encryption managing method. The present invention can also be realized as a program for the computer to execute the steps included in the encryption managing method.

Therefore, the present invention can provide a method for managing encryption schemes that can ensure high security.

### FURTHER INFORMATION ABOUT TECHNICAL BACKGROUND TO THIS APPLICATION

The disclosure of Japanese Patent Application No. 2005-330687 filed on Nov. 15 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic diagram showing a configuration of an encryption managing device according to the present invention;

FIG. 2 is a block diagram showing a configuration of an encryption managing device in a first embodiment;

FIG. 3 is a flowchart showing an encryption method renewal by the encryption management device in the first embodiment;

FIG. 4 is a diagram showing an example of encryption method switching request screen on the web;

FIG. 5 is a diagram showing a typical information addition of memory address in the reconfiguration information generating unit;

FIG. 6 is a diagram showing a typical circuit formed on a reconfigurable device;

FIG. 7 is a block diagram showing a configuration of the encryption management device in a second embodiment; and

FIG. 8 is a flowchart showing an encryption method renewal by the encryption managing device in the second embodiment.

### DESCRIPTION OF THE PREFERRED EMBODIMENT(S)

The preferred embodiments of a method for managing encryption schemes according to the present invention are described hereafter in detail with reference to the diagrams.

### First Embodiment

According to the encryption scheme management device in this embodiment, the circuit is formed in compliance with an encryption scheme selected from among plural encryption schemes. The circuit facilitates switching encryption schemes. When distributing content data, it is possible to selectively utilize, not a fixed encryption scheme but various encryption schemes when transmitting encrypted signals, ensuring high security.

First of all, a configuration of the encryption schemes managing device according to the first embodiment is described.

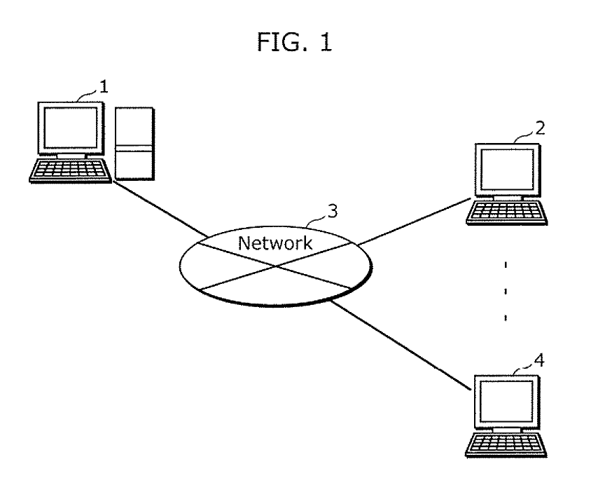

FIG. 1 is a schematic diagram showing a configuration of an encryption managing device of the first embodiment.

As shown in FIG. 1, the encryption schemes management device in the first embodiment includes a server device 1, and client devices 2 and 4.

The server device 1 manages encryption schemes utilized for distributing encrypted data, and is connected to the client devices 2 and 4 via a network 3. The server device 1 sends, according to a request from the client device 2 or 4, reconfiguration information, which is configuration data for forming a circuit, in the client device 2 or 4, to decrypt the encrypted data via the network 3. Note that the server device 1 is a server which distributes encrypted content data via the network 3 according to a request from the client device 2 or 4.

The client device 2 and 4 are PCs (personal computers) and the like which a client (user) operates. The client device 2 or 4 sends an encryption scheme switching request. The client device 2 or 4 sends content distribution requests to the server device 1, decrypts the distributed encrypted content data, and obtains the content.

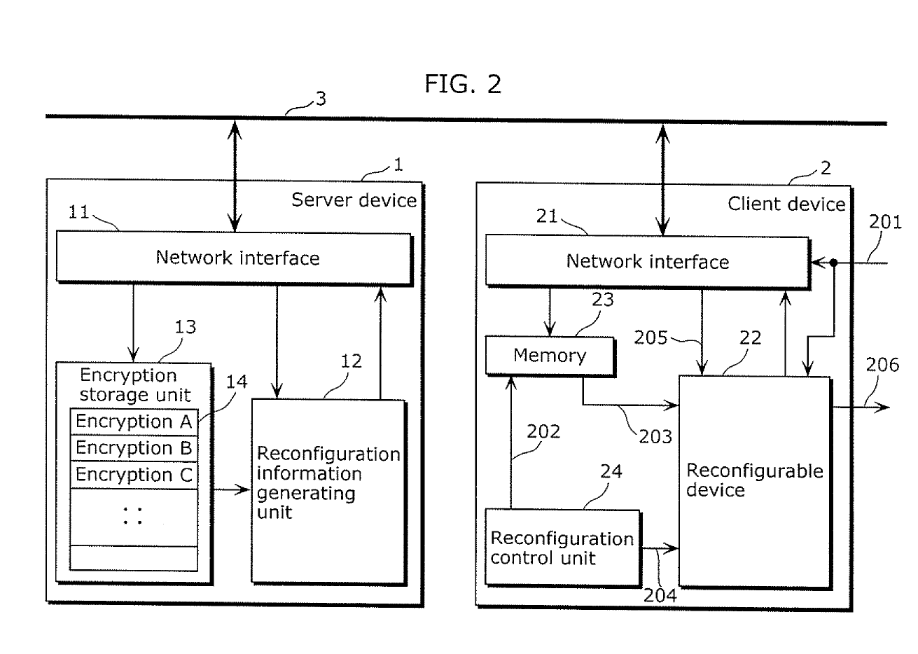

FIG. 2 is a block diagram showing the configuration of the encryption managing device shown in FIG. 1.

As shown in FIG. 2, the server device 1 includes a network interface 11, a reconfiguration information generating unit 12, and an encryption storage unit 13. The client device 2 includes a network interface 21, a reconfigurable device 22, a memory 23, and a reconfigurable control unit 24.

The network interface 11 performs data delivery and receipt between the server device 1 and the client device 2 via the network 3.

The reconfiguration information generating unit 12 generates reconfiguration information which is configuration data for forming a circuit in the reconfigurable device 22 equipped in the client device that decrypts encrypted data. The reconfiguration information generating unit 12 sends the generated reconfiguration information to the client device 2 via the network 3.

The encryption storage unit 13 stores encryption data 14.

The encryption data 14 is data which represents an encryption scheme algorithm. The encryption data 14 is written in a high-level programming language such as C language or the like, or a hardware description language. Note that the encryption scheme algorithms are the private-key cryptographies such as DES, 3DES, AES, RC2, RC4, RC5, IDEA, FEAL, MISTY, and the like, or public key cryptographies such as RSA, elliptic curve cryptography, and the like, or the one-way cryptography such as SHA-1, MD2, MD5, DH, and the like.

The network interface 21 performs data delivery and receipt between the server device 1 and the client device 2 via the network 3.

The reconfigurable device 22 is a programmable device that can modify circuit configuration using reconfiguration information (configuration data). For example, the reconfigurable device 22 is FPGA (Field Programmable Gate Array) or PLD (Programmable Logic Device) or the like.

The memory 23 is a memory element which stores reconfiguration information sent from the server device 1. The memory 23, for example, is a hard disk, a RAM, or the like.

The reconfiguration control unit 24 forms a circuit on the reconfigurable device 22 according to the reconfiguration information stored in the memory 23.

Next, the operation of the encryption managing device in the first embodiment is described.

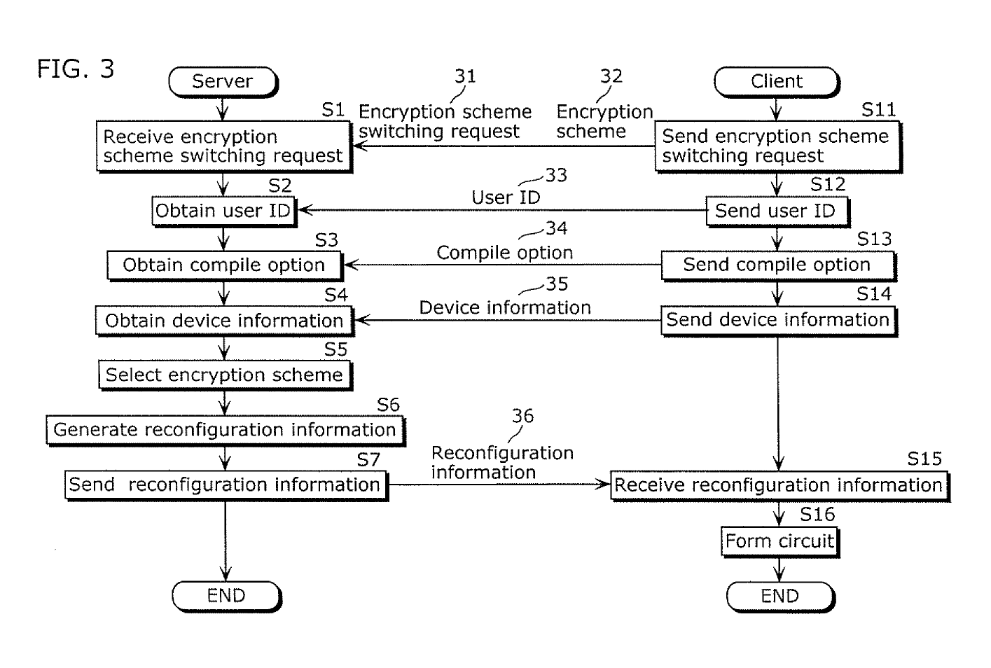

FIG. 3 is a flowchart showing an encryption method renewal by the encryption management device in the first embodiment.

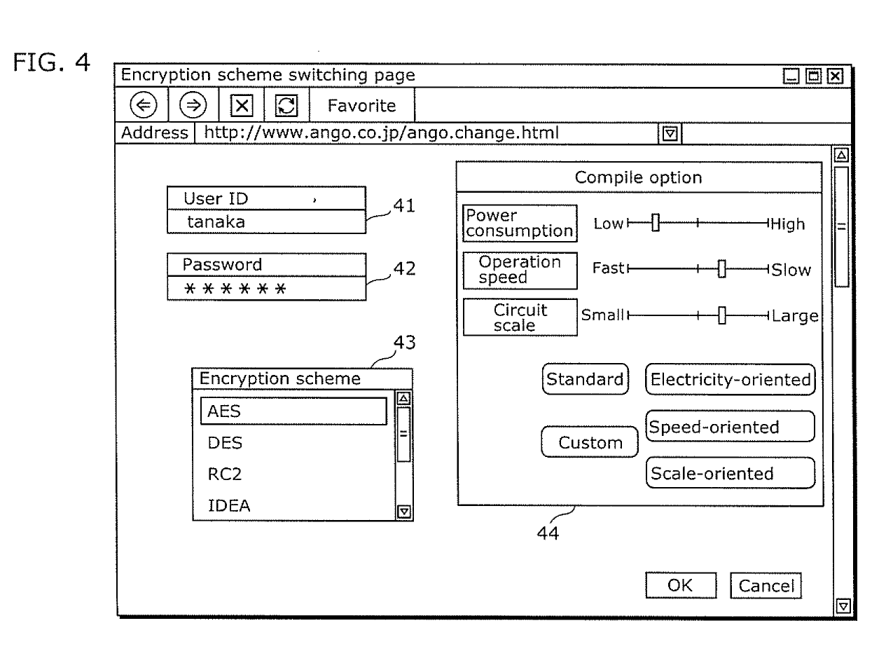

First, a client sends an encryption schemes switching request 31 by a client input 201 from the client device 2 to the server 1 via the network 3. The client device 2 sends a request for the encryption scheme 32 used for encrypting the content to be distributed (S11). The client device 2 sends a user ID 33 to the server 1 (S12). The client device 2 sends a compile option 34 which is a circuit condition formed in the reconfigurable device 22 (S13). FIG. 4 is a diagram showing an example of encryption method switching request screen on the web. For example, a user ID which is an ID unique to each user is set by a client input 201 in 41 shown in FIG. 4. In 42, a password is set. In 43, an encryption scheme utilized for content encryption is selected from the encryption schemes. For example, the encryption schemes are AES, DES, RC2, IDEA, and the like. In 44, the compile option which is a circuit condition which is formed in the reconfigurable device is set. For example, the compile option includes items such as power consumption, operation speed, circuit scale and the like.

The server device 1 receives a request for the encryption schemes switching request 31 and a request for the encryption scheme 32 sent from the client device 2 in Step 11 (S1). The server device 1 obtains the user ID 33 sent from the client device 2 in Step 12. For example, the user ID 33 includes a user-specific ID and a password (S2). The server device 1 obtains the compile option 34 sent from the client device 2 in Step 13 (S3).

The client device 2 sends device information 35 of the reconfigurable device 22 stored in the reconfigurable device 22 to the server device 1 via the network interface 21 and the network 3 (S14). Here, the device information 35 is a model number of the reconfigurable device or the like. The reconfiguration information generating unit 12 of the server device 1 obtains the device information 35 of the reconfigurable device 22 via the network interface 11 (S4).

The reconfiguration information generating unit 12 in the server device 1 selects the encryption data 14 specified in the request for the encryption scheme 32 received in Step S1 from the plural encryption data 14 stored in the encryption storage unit 13 (S5).

The reconfiguration information generating unit 12 generates reconfiguration information 36 which is configuration data for forming a circuit in the reconfigurable device 22 equipped in the client device 2 to decrypt the encrypted data, with the user ID 33 obtained in Step S2, the compile option 34 obtained in Step S3, the device information 35 of the reconfigurable device 22 obtained in Step S4, and the encryption data 14 selected in Step 5. the reconfiguration information generating unit 12 obtains the encryption data 14 selected in Step S5, and converts the data into configuration data. In other words, the reconfiguration information generating unit 12 generates the reconfiguration information 36 which is the configuration data for forming a circuit which decrypts the encrypted data encrypted with the encryption data 14 selected in Step S5. In addition, the reconfiguration information generating unit 12 generates the reconfiguration information 36 reflecting the circuit condition (the compile option 34) obtained in Step S3. Here, the circuit condition includes a low-power consumption circuit, a small scale circuit, a high-speed circuit and others. For example, in the case where a low power consumption circuit is set as the compile option, the reconfiguration information generating unit 12 generates the reconfiguration information 36 for forming a circuit prioritizing low-power consumption. The circuit prioritizing low-power consumption is a circuit with a large circuit scale and a low operating frequency, and the like. In the case where a small circuit scale is set as a compile option, the reconfiguration information generating unit 12 generates the reconfiguration information 36 for forming a circuit in the reconfigurable device 22 prioritizing circuit scale. Therefore, the encryption managing device in the first embodiment can form a decrypting circuit adapted to the usage environment of the client device 2 by the compile option in the reconfigurable device 22 while maintaining the same function.

In addition, the reconfiguration information generating unit 12 generates the reconfiguration information 36 compliant with the reconfigurable device 22 using the device information 35 obtained in Step S4. With this, even when the model of the reconfigurable device 22 equipped in the client device 2, it is possible to generate the reconfiguration information 36 adapted to the reconfigurable device 22 equipped in the respective client devices 2.

In addition, the reconfiguration information generating unit 12 generates the reconfiguration information to form a circuit dependent on the user ID 33 obtained in Step S2 (S6). For example, the reconfiguration information generating unit 12 adds information on the memory address where the key which is stored in the client device 2.

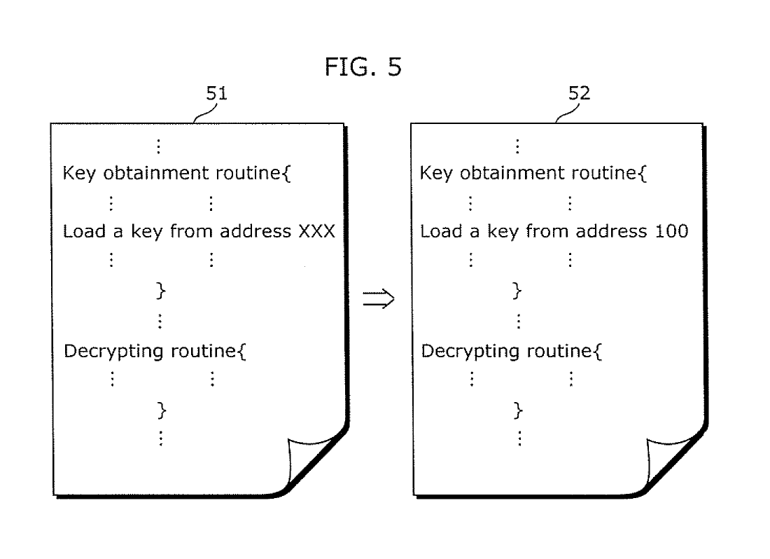

FIG. 5 is a diagram showing an overview of information addition of memory address in the reconfiguration information generating unit.

As shown in 51 in FIG. 5, in the encryption data stored in the encryption storage unit 13, a key reading address for the key obtainment routine is not listed. As shown in 52 in FIG. 5, the reconfiguration information generating unit 12 set the key reading address, for example, number 100. The memory address where the key is stored is unique to each client device 2. Thus, even if other client devices or the like receive the reconfiguration information 36 and forms a circuit in the reconfigurable device 22, it is impossible for other clients to decrypt the encrypted content data because the key reading address does not match. Therefore, the encryption managing device in the first embodiment can ensure high security when distributing content data. For example, the memory address where the key is stored is determined by the user ID 33 obtained in Step S2 and the table which is stored in the server device 1.

The reconfiguration information generating unit 12 of the server device 1 sends the reconfiguration information 36 generated in Step S6 to the client device 2 via the network interface 11 and the network 3 (S7). The client device 2 receives sent reconfiguration information 36 and store the reconfiguration information 36 to the memory 23 via the network interface 21 (S15).

The reconfiguration control unit 24 of the client device 2 sends the reconfiguration information 36 stored in Step S15 from the memory 23 to the reconfigurable device 22 by a control signal 202 via a signal line 203. The reconfiguration control unit 24 forms a circuit specified in the reconfiguration information 36 in the reconfigurable device 22 by the control signal 204. In other words, the reconfiguration control unit 24 forms the circuit for decrypting the encrypted data with the selected encryption scheme in the reconfigurable device 22 (S16).

With the abovementioned operations, the circuit for decrypting the encrypted data distributed from the server device 1 is formed in the reconfigurable device 22 equipped in the client device 2. The client device 2 decrypts the encrypted content data 212 and outputs the decrypted data as data 206.

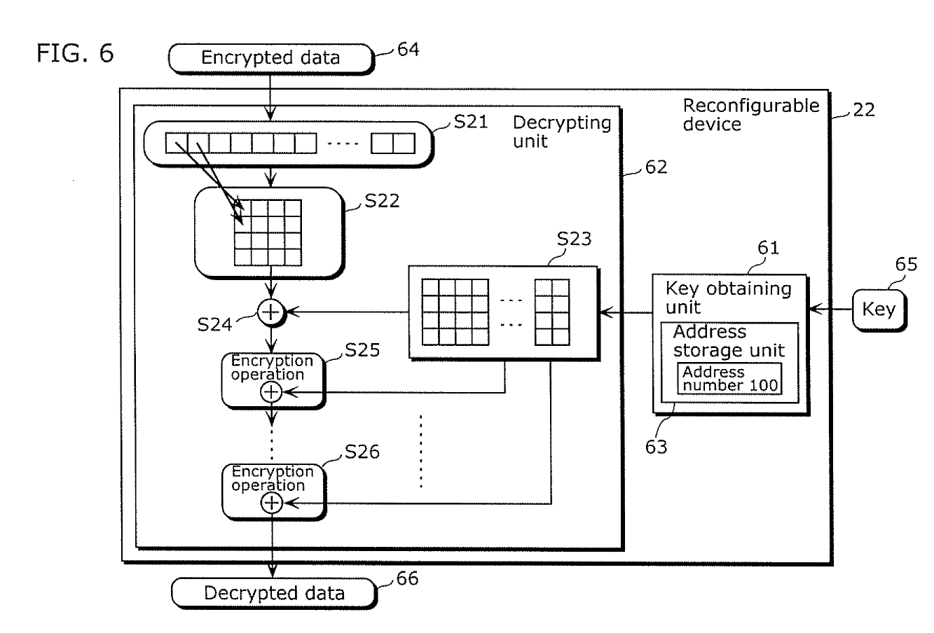

FIG. 6 is a diagram showing an overview of an operation performed by a circuit formed in a reconfigurable device 22.

For example, in the case where the AES is selected as an encryption scheme, a key obtaining unit 61 and a decrypting unit 62 are formed in the reconfigurable device 22 as shown in FIG. 6.

The key obtaining unit 61 includes an address storage unit 63, and obtains a key 65 utilized for decrypting the encrypted data 64. The address storage unit 63 stores an address where the key 65 is stored. For example, address 100 is stored as the memory address. This memory address is a value unique to the user and set in Step S6. Thus, even if other client device forms a decrypting circuit in a reconfigurable device using the reconfiguration information 36, the distributed content data can not be decrypted.

The decryption unit 62 decrypts the encrypted data 64. The following is a decryption of operations when the AES is used. First, the decrypted data 64 of 128 bits is divided into 8 bits×16 (S21). Then the 16 pieces of 8 bits data divided in Step S21 are aligned in 4×4 (S22).

The decrypting unit 62 expands the key 65 obtained by the key obtaining unit 61 according to a predetermined rule, and aligns the key in 4×N (S23). Here, the key 65 is 128, 192, or 256 bits.

An exclusive logical sum of the 4×4 data aligned in Step S22 and the 4×4 data of the key 65 aligned in Step S23 is calculated (S24).

Encryption operation of the data calculated in Step S24 and calculation of an exclusive logical sum of the data calculated in Step S24 and the 4×4 data of the key 65 aligned in Step s23 are performed. (S25) Step S25 is repeated several times (S26).

With the operations from Step S21 to S26, the encrypted data 64 is outputted as decrypted data 66.

In the encryption managing device in the first embodiment, in response to the encryption switching request by the client, the reconfiguration information generating unit 12 in the server device 1 generates the reconfiguration information 36 for forming a circuit in the reconfigurable device 22 equipped in the client device 2 for decrypting the content data encrypted by an encryption scheme selected by the encryption schemes, and sends the information to the client device 2. The client device 2, according to the sent reconfiguration information 36, forms the circuit for decrypting the encrypted content data in the reconfigurable device 22.

The client can decrypt the encrypted contents encrypted by the selected encryption scheme in the circuit formed in the reconfigurable device 22. Thus, the encryption scheme used for encrypting the distributed content can be switched easily. High security is ensured when distributing the content data since the content data is encrypted with various encryption schemes, not with a fixed encryption schemes.

In addition, the circuit for decrypting the content data is formed in the reconfigurable device 22 equipped in the client device 2, the client has no need to modify the hardware in the decrypting device. Thus, by using the encryption managing device of the first embodiment, even if the encryption scheme for content data is switched, the client is not required to perform a great number of operations.

In addition, a circuit dependent on the user ID is formed in the reconfigurable device 22. Thus, even when a device for decrypting the same encryption scheme is used, the encrypted data cannot be decrypted except for the client device 2 which sent the content request. Therefore, high security is ensured when distributing content data.

In addition, the reconfiguration information generating unit 12 obtains device information of the reconfigurable device 22 equipped in the client device 2 in Step S4, and using the information, generates reconfiguration information 36 for forming a circuit in the reconfigurable device 22. Thus, the reconfiguration information generating 12 can generate the reconfiguration information 36 compliant with the reconfigurable device equipped in the client device 2. Therefore, the reconfiguration information generating unit 12 can generate the reconfiguration information 36 in the case where the model of the reconfigurable device 22 varies.

In addition, the circuit formed in the reconfigurable device 22 reflects compile option se tin Step S3. Thus, the circuit to be formed in the reconfigurable device 22 can reflect client's request. In other words, a circuit for encrypting a encryption scheme adapted to the user environment can be formed in the reconfigurable device 22.

Although the encryption managing device in the first embodiment is described above, the present invention is not limited to this embodiment.

For example, although the server device 1 and the client device 2 directly deliver and receive data via the network 3 in the first embodiment, data delivery and receipt may also be performed via a third party on the network.

In addition, in the description above, the client device 2 sends the content distribution request to the server device 1, and the encrypted content data is distributed from the server device 1 to the client device 2, the present invention is not limited by the description. For example, the server device 1 may only perform the encryption scheme switching operation and another distribution server may distribute the content data. In the case where another distribution server distributes the content, the server device 1 sends information such as the selected encryption scheme and the user ID and the like. The distribution server encrypts the content using the encryption scheme, and sends the data to the client device.

In addition, although the client selects encryption schemes in the description above, the server device 1 may select encryption schemes individually. In addition, in the case where the server device 1 and the server for content distribution are separated, an encryption scheme is selected by an operation from the content distribution server. In this case, even the client does not know the encryption schemes to be encrypted by a circuit formed in the reconfigurable device 22. In other words, the selected encryption schemes cannot be seen from outside of the device. With this, it is difficult to decrypt content data even when the content data is obtained in an unauthorized manner. Therefore, high security is ensured when distributing the content data.

In addition, in FIG. 3, it is listed that the client device 2 performs encryption schemes switching request (S11), User ID transmission (S12), compile option transmission (S13), and device information transmission (S14), although the operation should not be limited by the description. For example, the operations in Steps S11 to S14 may be performed at the same time. In addition, after Step S11, operations in Steps S12 to S14 can be performed in any order. When the order of Steps S11 to S14 is changed in the client device 2, the order of Steps S1 to S4 is changed as well in accordance with the change.

In addition, although the encryption data 14 stored in the encryption storage unit 13 is data written in a high-level programming language or a hardware description language in the description above, the present invention should not be limited by the description. For example, the encryption data 14 may be configuration data for forming a circuit in the reconfigurable device 22. In this case, in Step S6, the reconfiguration information generating unit 12 only adds the content for forming a circuit which is dependent on the user ID obtained in Step S2. Note that the encryption storage unit 13 may store plural configuration data for each model of the reconfigurable devices 22. In this case, configuration data corresponding to the model number of the reconfigurable device 22 is selected according to the device information obtained in Step S4.

Although the user ID contains an ID unique to a user and a password in the description above, it may also contain either the user-unique ID or a password.

In addition, in Step S6, although it is noted that the reconfiguration information generating unit 12 generates reconfiguration information 36 for forming a circuit dependent on the user ID obtained Step S2 in the reconfigurable device 22, without this operation, the reconfiguration information 36 for forming a decrypting circuit independent of the user ID may be generated. In this case, it is unnecessary to perform operations in Step S2 or S12.

In addition, although the client inputs information on compile option and sends the information to the server device 1 in Step S13 in the description, the present invention should not be limited by the description. For example, the client device 2 may include a circuit which automatically judges a situation of the client device 2 and send the judgment results to the server device 1.

### Second Embodiment

In the encryption managing device according to the first embodiment, the reconfiguration information generating unit 12 equipped in the server device 1 generates the reconfiguration information 36 for forming a circuit in the reconfigurable device 22 in the client device 2. In the encryption managing device according to the second embodiment, the reconfiguration information for forming a circuit in the reconfigurable device 22 is generated in the client device 2. With this configuration, the server device 1 can send a program which is independent of the type of the reconfigurable device 22 and includes encryption scheme information to the client device 2, without the device information of the reconfigurable device 22. Therefore, it is possible to facilitate control of the encryption managing device.

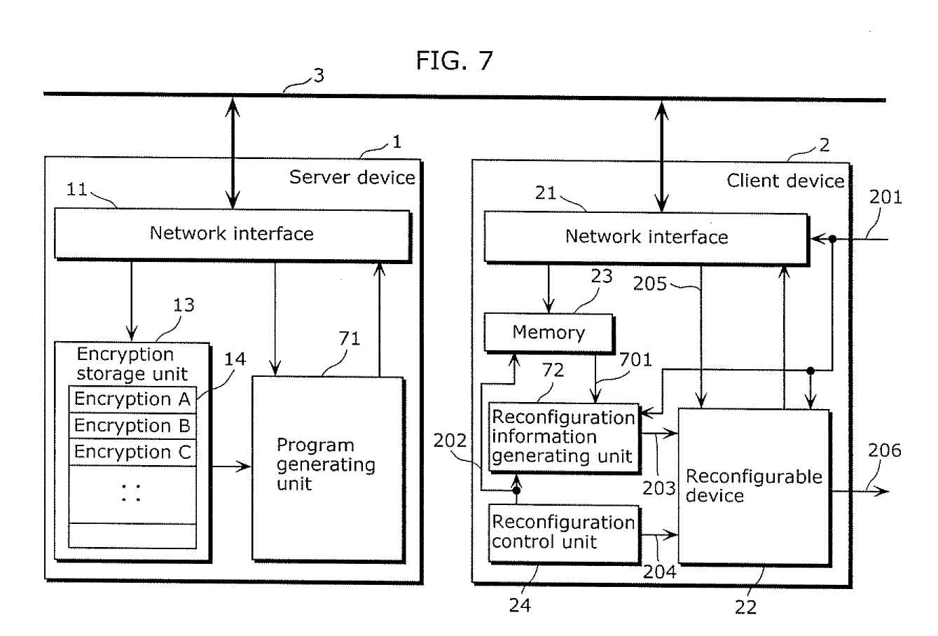

FIG. 7 is a block diagram showing a configuration of the encryption management device in the second embodiment. Note that the same reference numerals are used for the elements described in the first embodiment, which are shown in FIG. 2, and detailed descriptions for those elements are omitted.

The encryption managing device shown in FIG. 7 includes a program generating unit 71 in the server device 1. The program generating unit 71 generates a program for forming a circuit which decrypts encrypted data encrypted by an encryption scheme to be sent to the client device 2. Here, the program generated by the program generating unit 71 is a program written in either a high level programming language such as the C language or the like or a hardware description language, and is independent of the type of the device.

The client device 2 includes a reconfiguration information generating unit 72. The reconfiguration information generating unit 72 generates reconfiguration information which is configuration data for forming a circuit in the reconfigurable device 22 using the program sent from the server device 1.

The operations of the encryption managing device in the second embodiment are described hereafter.

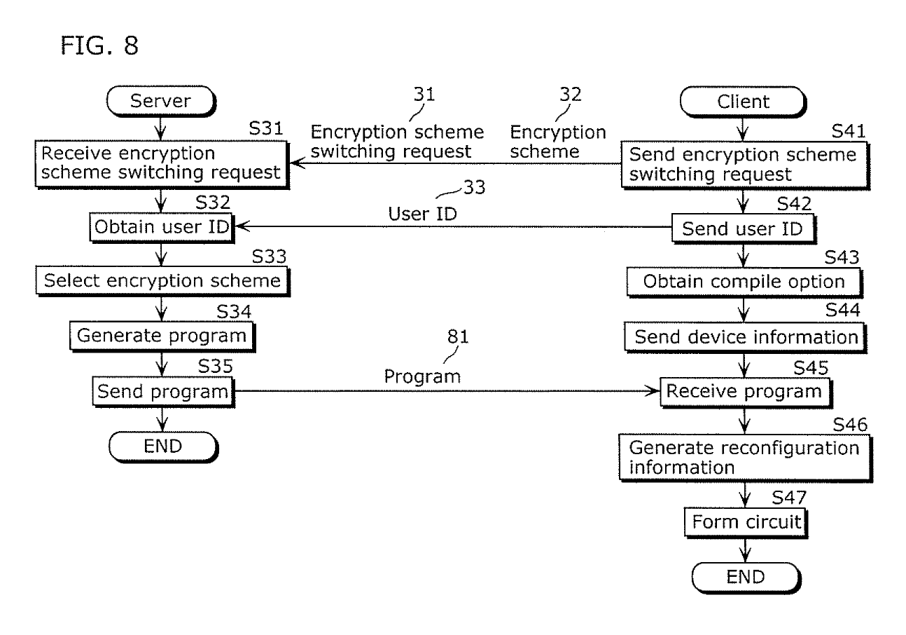

FIG. 8 is a flowchart showing an encryption method renewal by the encryption managing device in the second embodiment.

First, with a client input 201, the client sends the encryption schemes switching request 31 from the client device 2 to the server device 1 via the network 3. The client also sends, from the client device 2, a request for the encryption scheme 32 to be used for encrypting the content data to be distributed (S41).

Next, the client device 2 sends the user ID 33 to the server device 1 via the network 3 (S42). The user ID includes, for example, includes a user-unique ID and a password. The reconfiguration information generating unit 72 in the client device 2 obtains compile option information with the client input 201 (S43).

The reconfiguration information generating unit 72 in the client device 2 obtains device information of the reconfigurable device 22 (S44).

The program generating unit 71 in the server device 1 receives the encryption schemes switching request 31 and the encryption scheme 32 which are sent from the client device 2 in Step S41 (S31). In addition, the program generating unit 71 obtains the user ID 33 sent from the client device 2 in Step S42.

The program generating unit 71 in the server device 1 selects the encryption data 14 corresponding to the encryption schemes 32 received in Step S31 (S33).

The program generating unit 71 generates a program for forming a circuit which decrypts encrypted data encrypted by the encryption scheme of the encryption data 14 selected in Step S33. The program generating unit 71 generates a program 81 which includes information of a circuit for authenticating the user ID obtained in Step S12 (S34). For example, information of memory address where the key is stored in the client device 2 is added to the program which is generated by the program generating unit 71. In addition, the program 81 is a program written in a high-level programming language such as the C language or a hardware description language or the like, and is independent of the type of devices.

The program generating unit 71 of the server device 1 sends the program 81 generated in Step S34 to the client device 2 via the network interface 11 and the network 3 (S35). The client device 2 receives the program 81, and stores the program 81 in the memory 23 via the network interface 21. (S45)

The reconfiguration control unit 24 in the client device 2 sends the program 81 stored in Step S45 with the control signal 202 from the memory 23 to the reconfiguration information generating unit 72 via a signal line 701. The reconfiguration information generating unit 72 generates, using the sent program 81, the compile option obtained in Step S43, and the device information obtained in Step S44, reconfiguration information which is configuration data for forming a circuit in the reconfigurable device 22. In other words, the reconfiguration information generating unit 72 converts program written in a high-level programming language or a hardware description language or the like into configuration data (S46).

The reconfiguration control unit 24 sends, by the control signal 202, the reconfiguration information generated in Step S46 from the reconfiguration information generating unit 72 to the reconfigurable device 22 via the signal line 203. The reconfiguration control unit 24 forms a circuit adapted to the reconfiguration information in the reconfigurable device 22 with the control signal 204. In other words, the reconfiguration control unit 24 forms a circuit for decrypting the encrypted data encrypted with the encryption scheme 32 selected in the reconfigurable device 22 (S47).

With the operations described above, a circuit which decrypts the encrypted content data distributed from the server device 1 is formed in the reconfigurable device 22 in the client device 2.

As described above, in the encryption scheme managing device of the second embodiment, the program generating unit 71 in the server device 1 sends the program 81 for forming a circuit in the client device 2, independent from the type of devices, for decrypting the encrypted data encrypted by the selected encryption scheme, in response to the encryption switching request by the client. The reconfiguration information generating unit 72 in the client device 2 converts the sent program 81 into the reconfiguration information for forming a circuit which decrypts encrypted content data in the reconfigurable device 22 in the client device 2. The client device 2 forms a circuit for encrypting the encrypted content using the converted reconfiguration information.

Thus, configuration information of a circuit formed in the reconfigurable device 22 (such as netlist) is not included in the program 81 which the server device 1 sends to the client device 2. Thus, the information on the decrypting circuit to be formed in the reconfigurable device 22 in the client device does not leak to the outside. Therefore, high security is ensured when distributing content data.

In addition, the encryption scheme management device of the second embodiment generates the program 81 for forming a circuit, in the reconfigurable device 22, which decrypts encrypted data encrypted with the selected encryption scheme, and sends the program to the client device 2, instead of obtaining device information of the reconfigurable device 22 in the client device 2 via the network 3. In addition, the client device 2 is not required to send information of compile options for a circuit to be formed in the reconfigurable device 22. Therefore, compared with the encryption managing device in the first embodiment, the amount of data transmitted between the server device 1 and the client device 2 is reduced. In addition, the processing amount in the server device 1 can be reduced as well.

Note that although it is described that the information of compile option is inputted by the user in the description above, it is not limited to this. For example, the client device 2 may have a circuit which determines the status of the client device 2, and the compile option can be automatically set from the judgment result.

It is also noted that although in FIG. 8, the operation of the client device 2 is listed from the encryption schemes switching request (S41) to the user ID transmission (S42), the operations in S41 and S42 may be performed at the same time.

In addition, although the compile option obtainment (S43) and the device information obtainment (S44) are performed after Step S42 in FIG. 8, it is not limited to this. Steps S43 and S44 can be performed at any time after S41 and prior to generating reconfiguration information (S46). Alternatively, Step S43 may be performed after Step S44.

In addition, in Step S34, the program generating unit 71 generates the program 81 for forming a circuit including information of the user ID obtained in Step S32. Instead of the operation, the selected encryption data 14 may be sent directly to the client device 2. In this case, the operations in Step S32 and S42 may not have to be performed.

Although in the description above, the encryption data 14 and the program sent by the program generating unit 71 is an encryption algorithm written in a high-level programming language or a hardware description language, it is not limited to this. For example, the encryption data 14 may be information for identifying an encryption scheme (for instance, name of the encryption scheme and the like). In this case, the client device 2 stores encryption algorithm written in a high-level programming language or a hardware description language adapted to the information. The reconfiguration control unit 24 selects an encryption algorithm corresponding to the information identifying the encryption scheme sent from the server device 1. The reconfiguration information generating unit 72 generates reconfiguration information from the selected algorithm. In addition, the client device 2 may store a plurality of configuration data for forming a decrypting circuit in the reconfigurable device 22. In this case, the reconfiguration control unit 24 selects a corresponding configuration data using the information, sent from the server device 1, for identifying an encryption scheme. The reconfiguration control unit 24 forms a circuit, using the selected configuration data, in the reconfigurable device 22. The plural configuration data stored in the client device 2 are configuration data adapted to the reconfigurable device 22 in the client device 2. Therefore, it is not necessary to obtain device information in Step S44.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to an encryption managing method, and particularly to an encryption managing method for managing encryption schemes utilized for encrypting content data in a content distribution system and the like which distributes content via a network.

What is claimed is:

1. An encryption scheme management method in a server device managing encryption schemes utilized for a distribution of encrypted data, said method comprising:
receiving an encryption scheme switching request from a client device;
selecting an encryption scheme from a plurality of encryption schemes after the encryption scheme switching request is received;
generating circuit forming information used for forming a circuit in a reconfigurable device equipped in the client device, the circuit being for decrypting encrypted data encrypted by the selected encryption scheme; and
sending the circuit forming information to the client device.

2. The encryption scheme management method according to claim 1,
wherein the circuit forming information is configuration data for forming a circuit in the reconfigurable device,
said encryption scheme management method further comprises
obtaining device information of the reconfigurable device, and
in said generating, configuration data adapted to the reconfigurable device is generated using the obtained device information.

3. The encryption scheme management method according to claim 2, further comprising
obtaining a condition of a circuit to be formed in the reconfigurable device,
wherein, in said generating, the configuration data for forming a circuit in the reconfigurable device is generated, the circuit reflecting the obtained condition is generated.

4. The encryption scheme management method according to claim 2,
wherein said generating includes:
obtaining a program in which the algorithm of the selected encryption scheme is written in either a high-level programming language or a hardware description language; and
converting the program into configuration data.

5. The encryption scheme management method according to claim 1,
wherein the circuit forming information is a program written in either a high-level programming language or a hardware description language.

6. The encryption scheme management method according to claim 1, further comprising
obtaining a unique user ID held by the client device,
wherein, in said generating, the circuit forming information for forming a circuit dependent on the user ID is generated.

7. The encryption scheme management method according to claim 1,
in said selecting, an encryption scheme to be used is selected independently of a request from the client device.

8. The encryption scheme management method according to claim 1,
in said receiving, the encryption scheme switching request includes an encryption scheme request utilized for encrypting,
in said selecting, an encryption scheme specified in the encryption scheme request is selected.

9. An encryption scheme management method in a client device which receives encrypted data, said method comprising:
sending an encryption scheme switching request to a server device;
receiving circuit forming information for forming, in the reconfigurable device equipped in the client device, a circuit for decrypting the encrypted data; and
forming a circuit in the reconfigurable device, using the circuit forming information, the circuit being for decrypting the encrypted data.

10. The encryption scheme management method according to claim 9, further comprising
sending device information of the reconfigurable device to the server device,
wherein the circuit forming information is configuration data for forming, in the reconfigurable device, a circuit for decrypting the encrypted data, and
the configuration data is configuration data adapted to the reconfigurable device.

11. The encryption scheme management method according to claim 9,
wherein the circuit forming information is a program written in either a high-level programming language or a hardware description language,
said encryption scheme management method further comprising
generating, from the program, configuration data for forming a circuit for decrypting the encrypted data, in the reconfigurable device equipped in the client device, and
in said forming, the circuit for decrypting the encrypted data is formed using the configuration data in the reconfigurable device.

12. The encryption scheme management method according to claim 11, further comprising
obtaining a condition of a circuit to be formed in the reconfigurable device,
wherein, in said generating, configuration data reflecting the obtained condition is generated, and
in said forming, a circuit reflecting the obtained condition is generated in the reconfigurable device.

13. The encryption scheme management method according to claim 12,
wherein the condition of the circuit includes a condition whether or not the circuit to be formed in the reconfigurable device is a low-electric consumption circuit.

14. The encryption scheme management method according to claim 11,
wherein said generating further includes
converting the program into configuration data.

15. The encryption scheme management method according to claim 9, further comprising:
sending a unique user ID held by the client device to the server device,
wherein in said receiving, the circuit forming information for forming a circuit dependent on the user ID is obtained, and
in said forming, the circuit dependent on the user ID is formed in the reconfigurable device.

16. The encryption scheme management method according to claim 9,
wherein, in said sending, the encryption scheme switching request includes an encryption scheme request utilized for encryption,
the circuit forming information is for forming a circuit in the reconfigurable device, the circuit being for decrypting the encrypted data encrypted with the encryption scheme specified in the encryption scheme request, and
in said forming, the circuit for decrypting the encrypted data encrypted with the encryption scheme specified in the encryption scheme request is formed in the reconfigurable device.

17. An encryption scheme management method for managing encryption schemes utilized for a distribution of encrypted data, said method comprising:
sending an encryption scheme switching request from a client device to a server device;
receiving the encryption scheme switching request in the server device;
selecting, in the server device, an encryption scheme from among the encryption schemes after the encryption scheme switching request is received;
generating configuration data for forming a circuit in the reconfigurable device equipped in the client device, the circuit being for decrypting the encrypted data encrypted in the selected encryption scheme in either the server device or the client device; and
forming a circuit in the reconfigurable device, using the configuration data in the client device, the circuit being for decrypting the encrypted data encrypted with the selected encryption scheme.

18. The encryption scheme management method according to claim 17, further comprising:
sending device information of the reconfigurable device from the client device to the server device; and
obtaining, in the server device, the device information of the reconfigurable device,
wherein, in said generating, the server device generates configuration data adapted to the reconfigurable device, using the obtained device information, and
said encryption scheme management method further comprises
sending the configuration data from the server device to the client device.

19. The encryption scheme management method according to claim 18, further comprising:
sending a unique user ID held by the client device from the client device to the server device; and
obtaining the user ID in the server device,
wherein, in said generating, configuration data for forming a circuit dependent on the user ID in the reconfigurable device is generated, and
in said forming, the circuit dependent on the user ID is formed in the reconfigurable device,

20. The encryption scheme management method according to claim 18
wherein said generating further includes:
obtaining a program of the selected encryption scheme algorithm written in either a high-level programming language or a hardware description language; and
converting the program into configuration data.

21. The encryption scheme management method according to claim 17, further comprising:
generating a program, in the server device, written in either a high-level programming language or a hardware description language, the program being for forming, in the reconfigurable device, a circuit for decrypting the encrypted data encrypted with the selected encryption scheme;
sending the program from the server device to the client device; and
receiving the program in the client device,
wherein, in said generating, the client device converts the program into configuration data.

22. The encryption scheme management method according to claim 21, further comprising:
sending a unique user ID held by the client device has from the client device to the server device; and
obtaining the user ID in the server device,
wherein, in said generating of the program, the program for forming a circuit dependent on the user ID is generated,
in said generating of the configuration data, the configuration data is generated for forming a circuit in the reconfigurable device, the circuit being dependent on the user ID,
in said forming, the circuit dependent on the user ID is formed in the reconfigurable device.

23. The encryption scheme management method according to claim 17
wherein the encryption scheme switching request includes an encryption scheme request utilized for encryption, and
in said selecting, an encryption scheme specified in the encryption scheme request is selected.

24. The encryption scheme management method according to claim 17,
wherein, in said selecting, an encryption scheme is selected independently of the request from the client device.

25. The encryption scheme management method according to claim 17, further comprising
obtaining a condition of a circuit to be formed in the reconfigurable device by either the server device or the client device,
wherein, in said generating, configuration data reflecting the obtained condition is generated, and
in said forming, a circuit reflecting the obtained condition is formed in the reconfigurable device.

26. The encryption scheme management method according to claim 25,
wherein the condition of the circuit includes a condition whether or not the circuit to be formed in the reconfigurable device is a low-electric consumption circuit.
